(19) United States
(12) Patent Application Publication
(10) Pub. No.: US 2007/0188560 A1
(43) Pub. Date: Aug. 16, 2007

(54) Droplet deposition apparatus

(75) Inventors: Werner Zapka, Jarfalla (SE); John Corrall, Cambridgeshire (GB)

Correspondence Address: MARSHALL, GERSTEIN & BORUN LLP, 233 S. WACKER DRIVE, SUITE 6300, SEARS TOWER, CHICAGO, IL, 60606, US

(73) Assignee: XAAR TECHNOLOGY LIMITED, CAMBRIDGESHIRE (GB)

(21) Appl. No.: 10/590,620

(22) PCT Filed: Feb. 28, 2005
(86) PCT No.: PCT/GB05/00739

§ 371 Date: Jan. 22, 2007

(30) Foreign Application Priority Data
Feb. 26, 2004 (GB) GB 0404231.3

(51) Int. Cl. B41J 2/05

(52) U.S. Cl. 347/61

(57) ABSTRACT

Ink jet apparatus with two piezoelectric actuators arranged back-to-back on parallel thermal management surfaces of a water-cooled chassis. The chassis is formed by the bringing together of two concave plastic molded parts, having high thermal conductivity. A common nozzle plate attached to the two actuators helps to ensure accurate nozzle alignment.

The present invention relates to droplet deposition apparatus and in particular drop on demand ink jet printing apparatus.

In the field of inkjet printing, image quality is often measured in terms of dots per inch (dpi) where the higher the number of dots the better the image. Whilst this is a general rule of thumb it is not true in all cases. For example the dots may be of such a size that decreasing the spacing between them will make no improvement to the image quality. In fact, in these situations the quality may be reduced since excess ink is deposited that causes bleeding, cockling and strikethrough.

The majority of commercially available inkjet printers are capable of depositing a single dot size. However, the quality of an image, as perceived by the human eye, is improved by depositing variable sized droplets rather than just single sized droplets. The technique of depositing variable sized drops is known in the art as greyscale.

A print head that is capable of printing with 15 different drop sizes at a resolution of 360 dpi can produce an image that, to the human eye, will appear to have a better quality than an identical image printed in binary at 720 or even 1440 dpi.

These higher dpi images must be created by repeatedly passing a print head over a substrate. Dots deposited on each pass are interleaved with previously printed dots. Since each pass takes a finite time to complete the time required to print an image is increased in proportion with the number of passes.

Certain print head constructions are capable of printing images at 360 dpi. Such a print head is exemplified in JP 4-259 563. Two actuators having a natural density of around 180 dpi are mounted on either side of a substrate in an offset arrangement to provide a print head having a natural resolution of 360 dpi. Such a print head is commonly known as a “back to back” actuator.

The ease at which actuators may be stacked to form a higher resolution print head is dependent on the natural resolution of the actuators. At 180 dpi a drop is deposited on the paper every 140 μm and 360 dpi a drop is deposited every 70 μm. Two 180 dpi actuators stacked to deposit an image at 360 dpi must ensure that droplets are deposited at regular and uniform 70 μm spacing. Failure to align the droplets correctly creates deficiencies in the quality of the image produced; for example lighter and darker bands may be being visible in an image error is commonly known as banding. A small tolerance either way of the optimum spacing is acceptable, however, and does not visibly affect the quality of the image. This tolerance is typically +/−15 μm in a 360 dpi head.

In the case where two 360 dpi actuators are stacked to give a 720 dpi image each ejected droplet should be arranged at a regular spacing of the order 35 μm. In this arrangement the tolerance on the spacing is reduced to around +/−7 μm.

Alignment is simplified by ensuring that the substrate to which the actuators are attached is slim—a thicker substrate of increases the separation of the two actuators and can increase errors in the optical alignment of one actuator with respect to the other.

An important issue for back to back actuators is one of thermal management. The actuator and the integrated circuits generate heat during operation of the print head, the integrated circuits being the major contributor to heat generation in a piezoelectric print head. For print heads utilising resistive heating to generate bubbles the major source of heat generation is the resistive elements themselves.

Looking in particular at a piezoelectric print head, the commonly used material PZT is a poor conductor of heat and can easily be cracked and damaged through differential thermal expansion.

It is also important that the temperature of a print head remains at a constant temperature during operation to avoid temperature dependent printing defects caused, for example, by variations in viscosity of the ink due to temperature fluctuations.

Where a single row print head is used, there is no real limit to the thickness of the base supporting the actuators. Therefore, this can be designed to be sufficiently large so as to absorb and conduct heat away from the actuator elements thereby minimising temperature variations.

In a back-to-back architecture there is double the heat generation than in a single row print head as there are double the number of actuators and chips. As discussed above, it is desirable to minimise the thickness of the support to aid manufacture. But, any reduction in thickness of the support reduces the volume of material available to transfer heat away from the actuators.

The present invention seeks to address this and other problems.

Thus, according to one aspect of the present invention there is provided droplet deposition apparatus comprising a chassis and at least first and second actuation means, each actuation means comprising an electrically actuable droplet ejection actuator and electrical drive circuitry to provide actuation signals to that actuator, wherein said chassis comprises two parallel, opposed thermal management surfaces, an internal fluid cavity situated between said thermal management surfaces such that fluid in said cavity establishes thermal contact with said surfaces and fluid ports arranged on the exterior of said chassis and communicating with said internal cavity for supply and circulation of fluid through said internal cavity; the first and second actuation means being mounted respectively on the two thermal management surfaces.

Advantageously, both the actuator and the drive circuitry of each actuation means are in thermal contact with the associated thermal management surface.

Suitably, each actuator comprises a body of piezoelectric material mounted in thermal contact with the associated thermal management surface.

Preferably the chassis is formed of a material having a high coefficient of thermal transfer. A particularly preferred material is a thermally conductive plastic, but other materials such as metals may also be appropriate.

Preferably the chassis is formed of multiple parts, said parts being combined to define the interval cavity. The multiple parts may be formed by moulding, or some other method and preferably the surfaces to which the actuators are mounted are machined to a required flatness. The surfaces preferably being machined after the multiple parts have been combined.

The internal cavity preferably comprises separator means thereby dividing said internal cavity into a first channel for providing thermal management for said actuators and a second channel for providing thermal management for integrated circuits. The divider means may be a wall, the relative dimensions of each channel preferably being chosen to provide an appropriate flow of fluid to either the integrated circuits or actuators depending on which generates the greater heat energy.

Preferably the fluid is water though a gas or another liquid may be appropriate. The inlet temperature of the fluid may be kept constant.

Alignment features may be formed or provided on the exterior surface of the chassis to aid alignment of the actuators or other components mounted on thereon.

Preferably the thickness between the mounting surfaces is less than 5 mm, more preferably less than 3 mm and even more preferably of the order 2 mm.

In another aspect, the present invention seeks to provide an improved method of manufacture.

Accordingly, the present invention consists in another aspect in manufacturing droplet deposition apparatus which comprises a chassis and at least first and second droplet ejection actuators; the method comprising the steps of: forming a chassis with first and second parallel, opposed thermal management surfaces and an internal fluid cavity situated between said thermal management surfaces; mounting the first and second droplet ejection actuators respectively on the first and second thermal management surfaces such that fluid in said cavity establishes thermal contact with both actuators; and providing a common nozzle plate which is disposed in a plane orthogonal to said thermal management surfaces and which defines a first set of nozzles for the actuator and a second set of nozzles for the second actuator such that the mutual alignment of the first and second sets of nozzles is independent of the mutual alignment of the first and second actuators.

The present invention will now be described, by way of example only, with reference to the following diagrams in which:

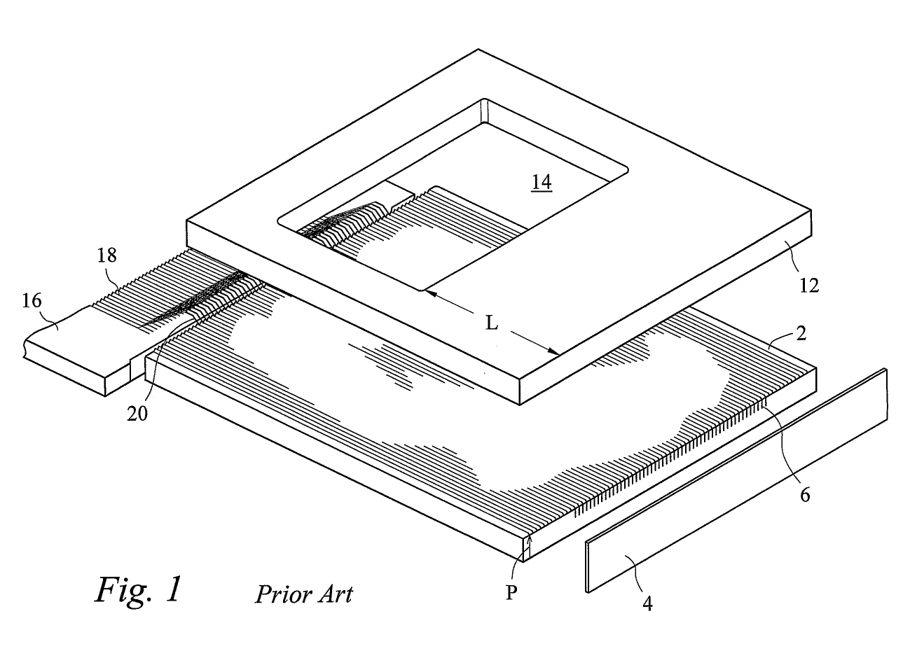

FIG. 1 shows a piezoelectric printer of the prior art having a single array of channels;

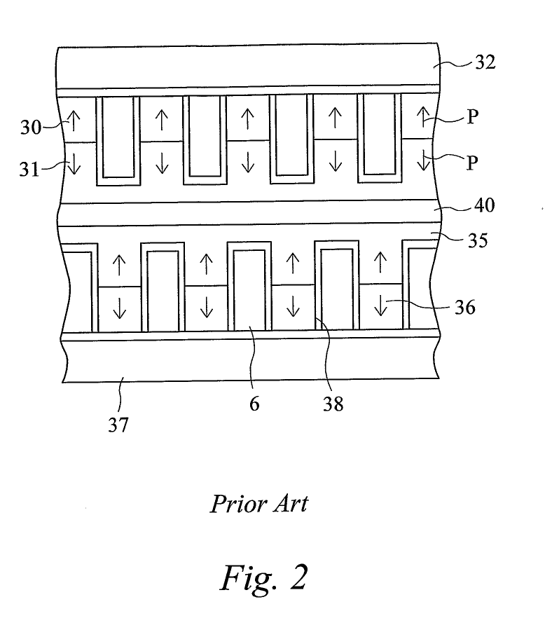

FIG. 2 shows in section a back-to-back actuator of the prior art;

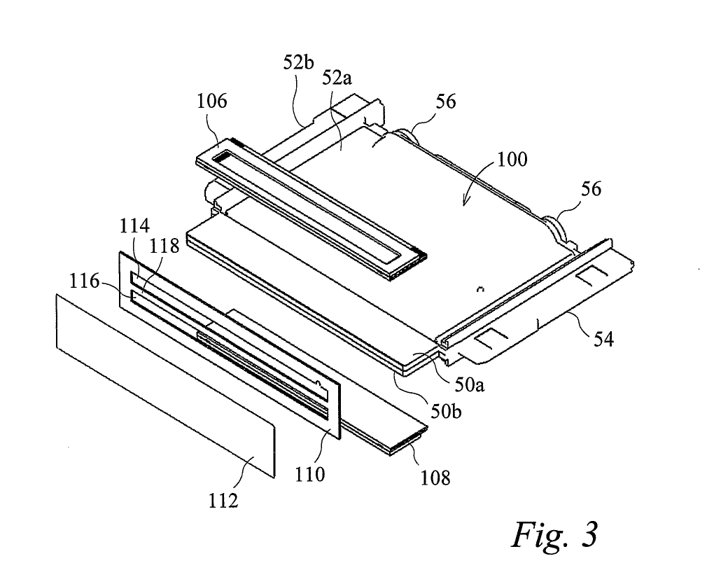

FIG. 3 shows apparatus according to the present invention in an exploded view of a chassis, two actuators and a nozzle plate arrangement;

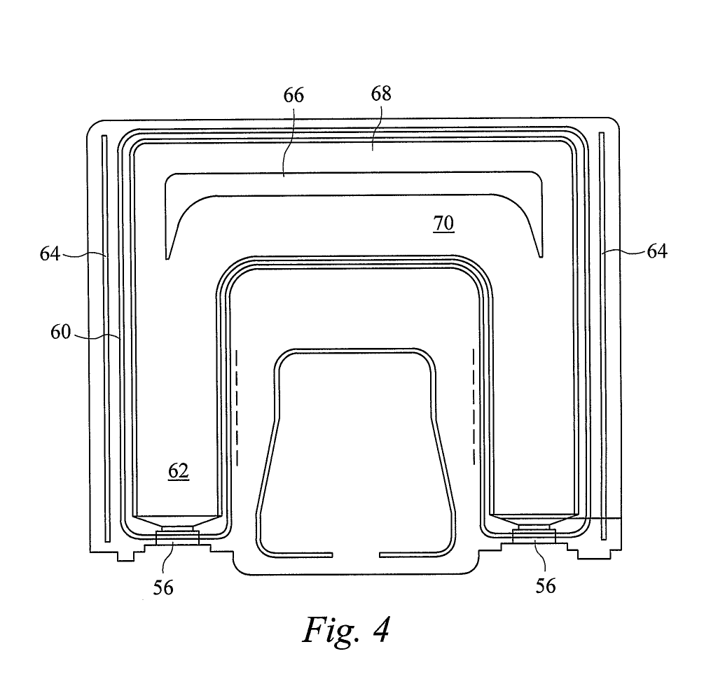

FIG. 4 depicts the internal features of the chassis provided by a first component of the chassis;

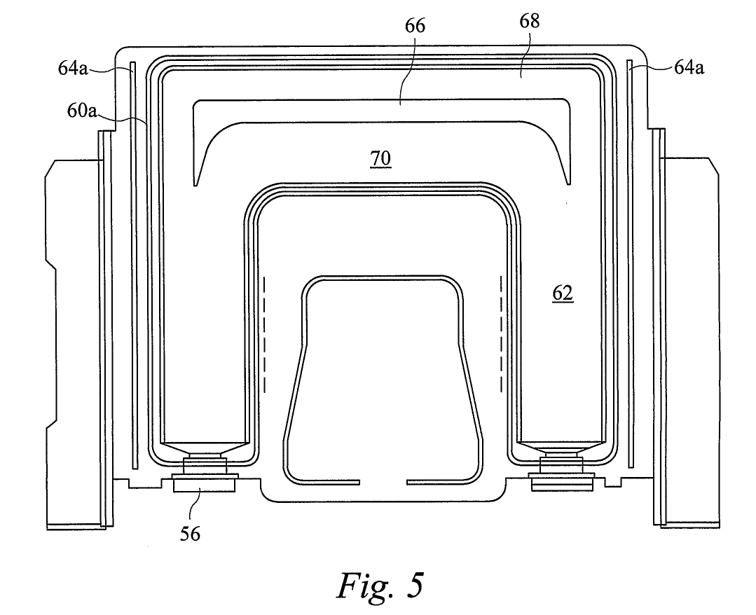

FIG. 5 depicts the internal features of the chassis provided by a second component of the chassis;

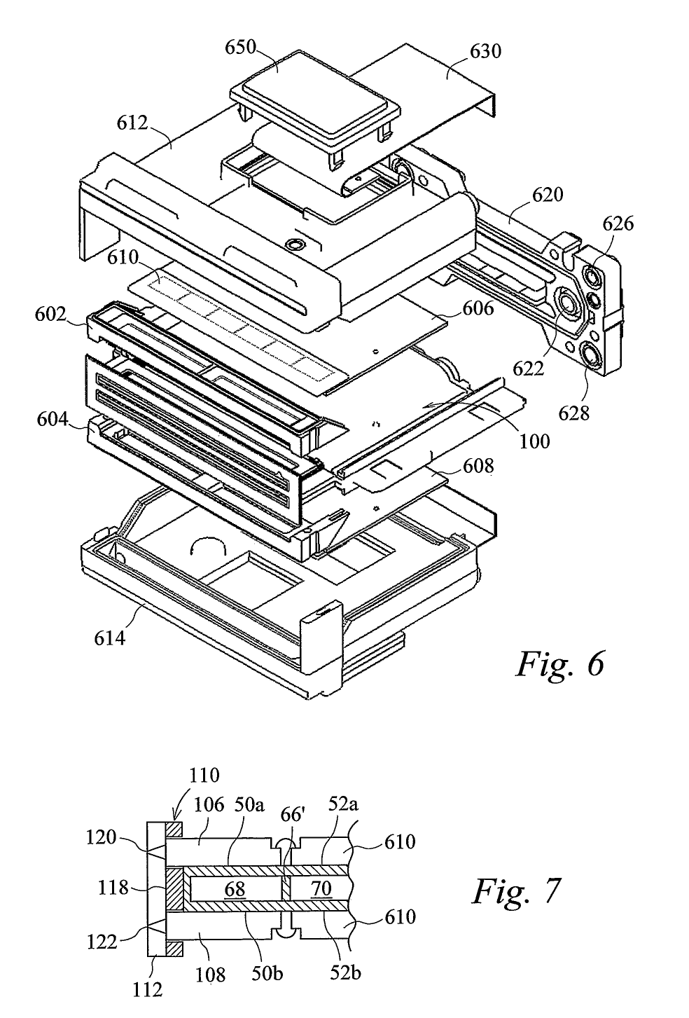

FIG. 6 shows the components seen in FIG. 3 together with an exploded view of the remaining components of apparatus according to the present invention; and

FIG. 7 is a sectional view to an enlarged scale illustrating the interrelationship of certain key components of the apparatus shown in FIG. 6.

FIG. 1 depicts a printhead of the prior art. Channels 6 are formed in a sheet of piezoelectric material 2, which is polarised in the direction of the arrow P. The walls that separate the channels have electrode material applied to them such that a voltage applied between the electrodes can cause the walls to deflect in shear. This initiates a pressure wave in the ink contained within the channel, with the pressure wave converging at a nozzle formed in the nozzle plate 4 to produce droplet ejection.

At the rear of the actuator a substrate 16 is provided that contains electric tracks 18 further connected to driver chips (not shown). The tracks are wire bonded at 20 to the electrodes on the walls 8, 10 to form an electrical connection. In alternative arrangements, the substrate 16 extends below the channelled component 10 and acts as a chassis for the piezoelectric material.

The tops of the channels are bounded by a cover plate 12 having an aperture 14 that acts as an ink manifold allowing ink to enter the channels. The active length of the channel—being the distance travelled by the acoustic wave in the ink—is determined by the length of the portion of the cover plate which closes the channels and is denoted by the letter L.

The ink manifold 14 is connected in any appropriate manner to a reservoir (not shown).

A nozzle plate 4 is attached to the front face of the actuator and contains nozzles (not shown), one per channel.

The mechanisms of droplet ejection from printheads of this type are well documented in the prior art and consequently will not be discussed in any further detail in the present application.

Back to back actuators are known in the prior art as depicted in FIG. 2. The actuator are each formed from layers of piezoelectric material. Layers 30, 31 and 35,36 are polarised in opposite directions as shown by the arrows P and laminated together to form sheets. These sheets are bonded to opposite sides of a central support 40. Channels 6 are sawn into the sheets and an electrode material 38 deposited on the defining surfaces of the dividing wall. The channels are closed by covers 32, 37.

FIGS. 3 to 7 depict apparatus according to the present invention.

Generally, the apparatus comprises a chassis 100 formed by the bonding together of two concave, plastics moulded parts 102 and 104. The chassis 100 is seen in its entirety in FIG. 3 and the two parts are shown individually in FIGS. 4 and 5. The chassis provides support in the form of thermal management surfaces (as further described below) for two actuation means, each of these comprising a piezoelectric actuator 106, 108 together with associated drive circuitry (as further described below). A nozzle support 110 is shaped and dimensioned to be bonded both to the chassis and to the nozzle plate 112 and to provide marginal support for the nozzle plate.

Turning to the detail of the chassis 100, towards the front of the substrate there are found parallel mounting surfaces 50a, 50b, spaced apart a distance of the order 3 mm in a direction perpendicular to the plane of the surfaces. A tighter tolerance on the distance between the surfaces (than could generally be expected in a moulding process) is achieved through a machining step where one or both mounting surfaces are mechanically or chemically machined to provide flatter surfaces. The present invention enables machining of the mounting surfaces without needing to machine other portions of the chassis.

Each surface has a length of the order 68 mm and a breadth of the order 14 mm and an area of the order 10 cm². These dimensions are sufficient to mount a shear mode, shared wall piezoelectric droplet deposition apparatus having around 350 channels, an active length of 1 mm and capable of firing 15 different drop sizes.

Second planar portions 52a, 52b adjacent to the mounting surfaces 50a, 50b provide a holding surface suitable for holding drive circuitry. Integrated circuits may be bonded directly to this surface of the chassis or may be mounted on an intermediate printed circuit board.

Wings 54 are provided at the side edges of the chassis and are provided with datum features and features to enable mounting of the print head into a printer. The wings are visible throughout manufacture and in the completed head can be provided with a bar code or some other marking device that can contain information about the head.

Ports 56 are provided to the rear of the chassis and allow coolant fluid, preferably water, to be circulated through an internal cavity in the chassis. The large upper and lower surfaces 50, 52 of the chassis ensure that the majority of the heat generating components can be efficiently cooled by the coolant fluid.

The material of the component parts is a thermally conductive plastic and suitably one known as Coolpoly and commercially available from Coolpolymers, Inc. The plastic provides good thermal conductivity of between 1.2 W/mK and 20 W/mK depending on the material chosen and is mouldable enabling external features described above and internal features described later to be cheaply and quickly manufactured. The ability to machine portions requiring higher tolerances that that which may be achieved by moulding is advantageous. Thermally conductive polymers are available that are electrically insulating and capable of being moulded, for example injection moulding. They can be based on liquid crystal polymers, poly phenylene sulphide, polyamide and polbutylene terephthalate as examples.

By moulding the component parts separately and joining together it is possible to provide internal features to the chassis that aid alignment of the two components, provide fluid seals and / or ensure a desired flow path of liquid through the chassis. By moulding and combining it is also possible to form narrow internal channels that allow the thickness of the chassis in key dimensions to be minimised.

FIG. 4 depicts the internal features of the chassis provided by a first component 102 of the chassis. The component comprises a projection 60 that extends around the periphery of the fluid containing portion 62. The projection mates with a groove provided on the second component 104 that forms the chassis and with the aid of an adhesive ensures a fluid-tight seal. Further projection portions 64 aids alignment of the components to each other.

A barrier portion 66 within the fluid containing portion divides an actuator-cooling channel 68 from a chip-cooling channel 70. The relative size of each of these channels and consequently the proportion of fluid flow through each of these channels is dependent on ratio of the relative heat generation of the chip and actuator. For a piezoelectric print head, as in this embodiment, the majority of the generated heat is provided from the chips and hence the chip cooling channel has a greater dimension than the actuator cooling channel.

FIG. 5 depicts the second component 104 of the chassis. It is substantially the same as the first component 102, with the exception that where projections are formed for the first component, complementary mating grooves 60a, 64a are provided in the second component.

A method of manufacturing apparatus according to the present invention will now be described.

The chassis 100 is formed by the bonding together of two moulded parts 102, 104 as described above. The surfaces 50a and 50b can be machined to ensure that the surfaces are flat, parallel and of the correct spacing. The first and second piezoelectric actuators 106 and 108 are then bonded to the respective surfaces 50a, 50b. Datum surfaces may be provided in the chassis to aid alignment. The piezoelectric actuators 106, 108 can, for example, be bonded to the surfaces 50a, 50b with thermally conductive adhesive.

A nozzle support 110, having parallel, elongate apertures 114, 116 is arranged, orthogonal to the surfaces 50a, 50b. The strip region 118 of the nozzle support lying between the apertures 114, 116 abuts the front edge of the chassis. This is seen most clearly in FIG. 7. The actuators 106 and 108 are positioned just proud of this chassis edge so as to extend, respectively, through the apertures 114 and 116 of the nozzle support 110. In this way, the support 110, together with the front edges of the actuators 106 and 108 provide a flush surface to which the nozzle plate 112 can be bonded. It will be appreciated that the nozzle support 110 provides support around the entire margin of the nozzle plate 112 and enables the nozzle plate 112 to be formed of a less robust material than would be required if the nozzle plate were self supporting.

Once the nozzle plate has been secured, two sets of nozzles 120,122 can be formed in a laser ablation process, one set of nozzles 120 corresponding with the ink channels of actuator 106 and the other set 122 corresponding with the ink channels of actuator 108. These two sets of nozzles will be spaced apart by an amount dictated by the thickness of the actuators and by the separation of the two surfaces 50a, 50b in the chassis 100. It will be understood that the nozzles are offset by one half of a nozzle pitch between one set and the other, to accommodate the relative offset between the channels in actuator 106 and the channels in actuator 108.

By forming the two sets of nozzles in a common nozzle plate, precise mutual alignment of the two sets of nozzles is readily assured. This mutual alignment is not dependent upon the two actuators being mutually aligned to the same degree of tolerance. It has been found that a small variation in the position of a nozzle with respect to the cross-section of the channel with which it communicates, is not material. As seen best in FIG. 7, this arrangement provides for good thermal conduct between each actuator 106, 108 and the “actuator-cooling” channel 68 of the internal chassis cavity.

In a typical configuration, a printhead according to the present invention is completed with further components as shown in FIG. 6. Ink filter modules 602, 604 engage with the chassis 100 and with the actuator 106, 108 to manage ink supply. Appropriate filtering is provided. Printed circuit boards 606, 608 carry integrated circuits 610 and are in close thermal contact with the thermal management surfaces 52a and 52b, respectively, of the chassis 100.

A top cover 612 and a bottom cover 614 are generally mirror images and sandwich of previously described components to seal ink flow paths. A backplate 620 provides cooling fluid inlet and outlet ports (only one, 622, seen) and ink inlet and outlet ports (only two, 626 and 628, seen). Electrical connection with the printed circuit board 606 and 604 is conveniently made through flexible connector 630, the connection of which is accessible through a snap-fit lid 650.

Whilst the above invention has been described with reference to a single actuator bonded to either surface it will be appreciated that multiple actuator components may be bonded to both surfaces. Preferably, the internal fluid cavity extents between and is in thermal communication with both actuators and both drive circuits. In some arrangements however, it will be sufficient for the cavity to extend between the drive circuits.

In a further modification, the surfaces 50a and 50b are apertured to allow direct contact between the cooling fluid and the piezoelectric material.

The advantage that the mutual alignment of the nozzle sets is not affected by small errors in the mutual alignment of actuators can be achieved also by bonding to the chassis and actuators a nozzle plate in which two sets of nozzles have already been accurately formed.

Whilst a back-to-back arrangement has been described, front-to-front or front-to-back alternatives may be appropriate in certain applications.

Each feature described in the diagrams, description or claims may be incorporated into the claims either individually or in combination with any other feature of features described herein.

1. Droplet deposition apparatus comprising a chassis and at least first and second actuator, each actuator comprising an electrically actuable droplet ejection actuator and electrical drive circuitry to provide actuation signals to that droplet ejection actuator, wherein said chassis comprises two parallel, opposed thermal management surfaces, an internal fluid cavity situated between said thermal management surfaces such that fluid in said cavity establishes thermal contact with said surfaces and fluid ports arranged on the exterior of said chassis and communicating with said internal cavity for supply and circulation of fluid through said internal cavity; the first and second actuator being mounted respectively on the two thermal management surfaces.

2. Apparatus according to claim 1, wherein both the droplet ejection actuator and the drive circuitry of each actuator are in thermal contact with the associated thermal management surface.

3. Apparatus according to claim 1, wherein each droplet ejection actuator comprises a body of piezoelectric material mounted in thermal contact with the associated thermal management surface.

4. Apparatus according to claim 3, wherein each body of piezoelectric material defines an array of droplet ejection channels and wherein the apparatus comprises a common nozzle plate which is disposed in a plane orthogonal to said thermal management surfaces and which defines a first set of nozzles for the droplet ejection channels of the first actuator and a second set of nozzles for the droplet ejection channels of the second actuator such that the mutual alignment of the first and second sets of nozzles is independent of the mutual alignment of the first and second actuator.

5. Apparatus according to claim 1, wherein said chassis is formed of a material having a thermal conductivity greater than 1.2 W/mK.

6. Apparatus according to claim 1, wherein said chassis is formed of a thermally conductive plastic.

7. Apparatus according to claim 1, wherein said chassis is formed from first and second generally concave chassis parts, each chassis part defining one of the thermal management surface parts and the chassis parts combining to define said internal cavity.

8. Apparatus according to claim 7, wherein said chassis parts are formed by molding.

9. Apparatus according to claim 8, wherein said thermal management surfaces are machined for mutual alignment after combination of said chassis parts.

10. Apparatus according to claim 1, wherein said internal cavity comprises a separator dividing said internal cavity into a first channel for providing thermal management for said droplet ejection actuators and a second channel for providing thermal management for said electrical drive circuitry.

11. Apparatus according to claim 10, wherein the second channel has a greater volume than the first channel.

12. A method of manufacturing droplet deposition apparatus which comprises a chassis and at least first and second droplet ejection actuators; the method comprising the steps of:
forming a chassis with first and second parallel, opposed thermal management surfaces and an internal fluid cavity situated between said thermal management surfaces;
mounting the first and second droplet ejection actuators respectively on the first and second thermal management surfaces such that fluid in said cavity establishes thermal contact with both actuators; and
providing a common nozzle plate which is disposed in a plane orthogonal to said thermal management surfaces and which defines a first set of nozzles for the actuator and a second set of nozzles for the second actuator such that the mutual alignment of the first and second sets of nozzles is independent of the mutual alignment of the first and second actuators.

13. A method according to claim 12, wherein the step of mounting the first and second droplet ejection actuators respectively on the first and second thermal management surfaces serves to define the mutual alignment of the first and second actuators in the apparatus.

14. A method according to claim 12, wherein each actuator comprises a body of piezoelectric material mounted in thermal contact with the associated thermal management surface.

15. A method according to claim 12, wherein said chassis is formed of a thermally conductive plastic.

16. A method according to claim 12, wherein said chassis is formed from first and second generally concave chassis parts, each chassis part defining one of the thermal management surface parts and the chassis parts combining to define said internal cavity.

17. A method according to claim 16, wherein said chassis parts are formed by molding.

18. A method according to claim 17, wherein said thermal management surfaces are machined for mutual alignment after combination of said chassis parts.

19. Droplet deposition apparatus comprising a chassis and at least first and second actuator, each actuator comprising a body of piezoelectric material defining an array of droplet ejection channels and electrical drive circuitry to provide actuation signals, wherein said chassis comprises two parallel, opposed thermal management surfaces, an internal fluid cavity situated between said thermal management surfaces such that fluid in said cavity establishes thermal contact with said surfaces and fluid ports arranged on the exterior of said chassis and communicating with said internal cavity for supply and circulation of fluid through said internal cavity; the first and second actuator being mounted respectively on the two thermal management surfaces, wherein both the body of piezoelectric material and the drive circuitry of each actuator are in thermal contact with the associated thermal management surface.

20. Apparatus according to claim 19, wherein the apparatus comprises a common nozzle plate which is disposed in a plane orthogonal to said thermal management surfaces and which defines a first set of nozzles for the droplet ejection channels of the first actuator and a second set of nozzles for the droplet ejection channels of the second actuator such that the mutual alignment of the first and second sets of nozzles is independent of the mutual alignment of the first and second actuation means.

21. Apparatus according to claim 19, wherein said chassis is formed of a molded plastic material having a thermal conductivity greater than 1.2 W/mK.

22. Droplet deposition apparatus comprising a chassis and at least first and second actuator, each actuator comprising a body of piezoelectric material and electrical drive circuitry to provide actuation signals, wherein said chassis is formed from first and second generally concave chassis parts, each chassis part defining one thermal management surface and the chassis parts combining to define an internal fluid cavity situated between said thermal management surfaces such that fluid in said cavity establishes thermal contact with said surfaces and fluid ports arranged on the exterior of said chassis and communicating with said internal cavity for supply and circulation of fluid through said internal cavity; the first and second actuator being mounted respectively on the two thermal management surfaces with the body of piezoelectric material and the drive circuitry of each actuator being in thermal contact with the associated thermal management surface, wherein said internal cavity comprises a separator thereby dividing said internal cavity into a first channel for providing thermal management for each said body of piezoelectric material and a second channel for providing thermal management for each said electrical drive circuitry.

23. Apparatus according to claim 22, wherein said chassis is formed of a molded plastic material having a thermal conductivity greater than 1.2 W/mK.

24. Apparatus according to claim 22, wherein the second channel has a greater volume than the first channel.
